(19) United States
(12) Patent Application Publication
(10) Pub. No.: US 2004/0088358 A1
(43) Pub. Date: May 6, 2004

(54) Method and system for setting up a notification

(75) Inventors: Peter Pal Boda, Helsinki (FI); Daniela Oria, Vantaa (FI); Esa Koskinen, Espoo (FI)

Correspondence Address: BANNER & WITCOFF, 1001 G STREET N W, SUITE 1100, WASHINGTON, DC, 20001, US

(73) Assignee: NOKIA CORPORATION, Espoo (FI)

(21) Appl. No.: 10/287,918

(22) Filed: Nov. 5, 2002

(51) Int. Cl. G06F 15/16; G06F 15/177; H04L 12/16; H04Q 11/00

(52) U.S. Cl. 709/206; 709/220; 709/204; 370/260

(57) ABSTRACT

A method and system for setting up a notification for the user of a mobile communication device using simple, well-known mechanisms such as e-mail and natural language expressions. The method comprises the steps of: receiving a notification configuration, and generating one or more notification criteria con-elated to the notification configuration, such that the user is notified of communication meeting the notification criteria. The system includes a storage device for storing notification received from the user and the correlated notification criteria, and a processor in communication with the storage device that correlates the notification configuration to the notification criteria and provides notification to the user when a received communication meets the notification criteria. By using such a method and system the user only needs to forward a received communication to the notification system and the system will automatically set up a notification for communication sent by the sender of the original communication.

### FIELD OF THE INVENTION

This invention relates generally to notification methods for personal messaging and more specifically to configuration of notification methods for personal messaging.

### BACKGROUND OF THE INVENTION

Messaging services are becoming ever more popular among users of mobile communication devices. With the ever-expanding functionality of mobile communication devices, pervasive access to personal information such as calendars and e-mail is getting more emphasis. Notification services are a natural extension of this. Especially for corporate users, the notification feature brings an added value to a messaging system. The user configures the notification service to send a personal message to his or her mobile communication device notifying him or her of receipt of mail from a specified sender. By using such a notification service users can keep track of e-mails to their personal accounts even if they are away from their personal computer or otherwise don't have easy access to their e-mail account. For example, a user may be on vacation and not have easy access to his or her e-mail but still want to be notified if he or she receives an e-mail from an important client. By using a notification service in conjunction with a mobile communication device the user can remain in contact with the important client. The use of an e-mail reader further improves the utility of the notification service. E-mail readers are a technology which is becoming more and more prevalent. They allow users to retrieve their e-mails by phone. The e-mails are read to the user by a text-to-speech synthesizer.

The problem with conventional notification services is that setting up the notification often involves using non-intuitive interfaces and deep menu systems. To change the notification set-up, the user must access it through a Graphic User Interface (GUI) or menu and then use a series of sub-menus to modify it. The user may also need to use and remember complicated commands to implement the notification. Also currently, if a user wants to set up a notification after reviewing his e-mail on an e-mail reader, the user must exit the reader to access the notification service. Therefore, what is needed is a simple and intuitive method of setting up, reviewing and modifying notification settings that also does not require changing the mode of operation currently in use. Providing the most natural means of interaction modality, namely speech and natural language, enhances the user's experience and leads to more habitable interfaces.

### SUMMARY OF THE INVENTION

In a first aspect, a method of setting up a notification for the user of a mobile communication device comprises two steps: receiving a notification configuration from a user, and generating one or more notification criteria correlated to the notification configuration, such that the user is notified on receiving a communication which meets the notification criteria. In certain preferred embodiments, the receiving of a notification configuration may be performed using an e-mail protocol such as mail forwarding. In other embodiments the notification configuration may be specified using a web interface or the mobile communication device.

In a second aspect, a notification system has a processor, that upon executing computer executable instructions, performs the steps of: receiving a notification configuration from a user, correlating the notification configuration provided by the user to at least one notification criteria, and notifying the user of communication meeting the at least one notification criteria.

In another aspect, a server for providing notification to a user of a mobile communication device comprises a storage device for storing at least one notification configuration received from a user and notification criteria, and a processor in communication with the storage device that correlates the notification configuration to the notification criteria and provides notification to the user when a received communication meets the notification criteria.

In another aspect, a mobile communication device has a processor, that upon executing computer executable instructions, performs the steps of: providing a notification configuration from a user to a notification service using natural language, and notifying the user when notification is received from the notification service.

### BRIEF DESCRIPTION OF THE DRAWINGS

FIG. 1 shows one embodiment of a notification system as used in a wireless communication system.

FIG. 2 shows one embodiment of providing a notification configuration using natural language via e-mail.

FIG. 3 shows one embodiment of a confirmation of a set of notification ctiteria via e-mail.

FIG. 4 shows one embodiment of the operation of a notification system using e-mail.

FIG. 5 shows one embodiment of the operation of a notification system using an e-mail reader and voice commands.

FIG. 6 shows one embodiment of a server in a notification system.

### DETAILED DESCRIPTION OF THE INVENTION

Personal messaging is a pervasive technology and a common feature found on an ever-increasing number of mobile communication devices. The term “personal messaging” should be understood to include e-mail, Short Message Service (SMS) and Multimedia Messaging Service (MMS) messaging, instant messaging, and the like. The term “mobile communication device” should be understood to include cellular telephones; Personal Digital Assistants (PDAs) with telephonic or wireless communication capabilities such as those manufactured by PALM, Inc., for example; Instant Messaging Devices, such as those manufactured by Blackberry, Inc., for example; pagers; notebook computers with telephonic or wireless communication capabilities; and other mobile devices that can communicate using various transmission technologies (including CDMA, GSM, TDMA, SMS, WAP, Bluetooth, Wi-fi, and others) or media (radio, infrared, laser, and the like). Notification services are also becoming more common and functional and can be implemented in numerous ways including using personal messaging and paging technologies.

As used here the terms “notification service” or “notification system” are synonymous and include any system capable of receiving criteria and generating a notification to a user according to the provided criteria. Suitable criteria include, but are not limited to, receiving e-mail from a specific sender, receiving e-mail containing specific keywords, advertisements, weather reports, emergency notifications, appointments, stock prices, and local/tourist attractions. Further criteria include time and date restrictions for criteria listed above as well as time and date restrictions for actual notification. It may also be beneficial to include filtering means for criteria, for example SPAM filters. Notification may be provided to the user via the user's mobile communication device. The notification can be delivered using any suitable protocol for communication to a mobile communication device including SMS and MMS messaging, Wireless Application Protocol (WAP), traditional paging protocol, or the like. Other services, criteria, and notification protocol will be apparent to one skilled in the art given the benefit of this disclosure.

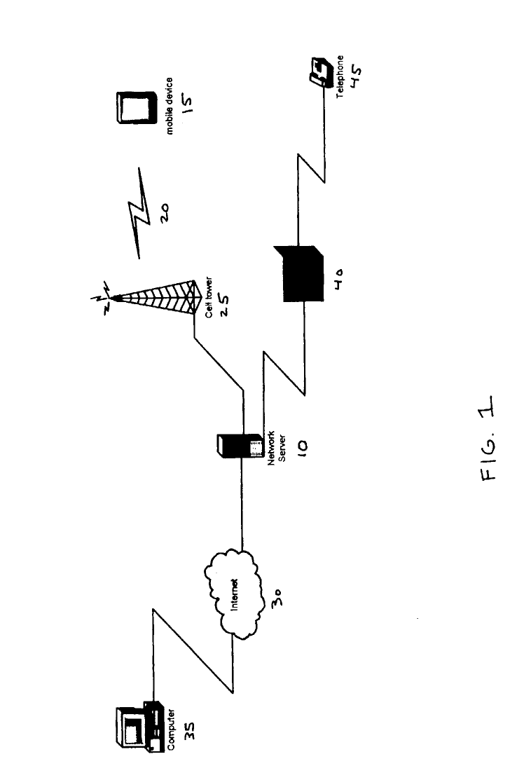

An example of a notification system in a wireless network can be seen in FIG. 1. A server 10 is in communication with the user's mobile communication device 15 via a wireless connection 20 provided over a cell tower 25. The server is also in communication with the user's personal computer 35 typically through the Internet 30. Additionally, in some embodiments, the user may communicate with the server using a telephone 45 using conventional telephone service (PSTN) 40 or Voice over Internet Protocol (VoIP)/Internet based service, for example.

The setting up of notifications can be facilitated by the use of a standard e-mail protocol such as mail forwarding. By using an e-mail protocol, the user does not need to learn complicated commands and interfaces possibly involving deep menu structures. For example, if the user wishes to set up a notification after reviewing an e-mail from a given sender, the user may use the e-mail browser to set up the notification by simply forwarding the e-mail to the notification service.

The setting up of notifications can be further facilitated by the use of Natural Language Understanding (NLU) technology. As with the e-mail protocol, when using natural language expressions, the user does not need to learn complicated commands with fixed and rigid syntax, or interfaces possibly involving deep menu structures. The use of Natural Language Understanding technology also integrates with other notification services or features without requiring a change in the mode of operation. For example, if the user wishes to set up a notification after reviewing an e-mail, the user may use the e-mail browser to set up the notification and use natural language expressions to set up further notification criteria such as time and date requirements. If the user is listening to his or her e-mail using an e-mail reader, the user could give voice commands and use natural language expressions to set up a notification.

As can be recognized by one skilled in the art, there are various ways to implement a notification system set-up. Several embodiments of e-mail or natural language enabled notification configurations are disclosed herein. Other embodiments, applications, and features will be apparent to one skilled in the art given the benefit of this disclosure.

In accordance with a first preferred embodiment, a method of setting up a notification includes: receiving a notification configuration, and generating one or more notification criteria correlated to the notification configuration, such that the user is notified of communication(s) meeting the notification criteria. In certain preferred embodiments the method also includes the step of providing the notification criteria for confirmation. In additional embodiments the method includes the step of editing notification criteria based on the notification criteria provided for confirmation.

The first step of the method includes receiving a notification configuration. One implementation of this step involves using e-mail protocol. For example, the user may be browsing his or her e-mail using a typical e-mail application such as Outlook, Eudora, Netscape, Pine, Elm, GroupWise or a Web-based e-mail service such as Hotmail, Yahoo or the like. If the user decides he or she wishes to be notified when he or she next receives an e-mail from a particular sender, the user may simply forward the e-mail from that particular sender to the notification system. The system is able to extract the original sender of the forwarded e-mail and add that sender to a notification list for the user. The fact that the user forwarded the e-mail indicates that the notification is for him or her.

The user may further add criteria for the date and time when he or she wishes to be notified using the subject line of the forwarded e-mail using natural language. For example, the user could use expressions such as “workdays”, “weekends”, “between 9 and 5”, “after work”, and “July 11 to August 2.” The system would be able receive such natural language criteria and correlate them to a restriction such as “Monday-Friday”, “Saturday and Sundays”, “between 9:00 am and 5:00 pm”, and “From July 11th to August 2nd”, respectively. It should be noted that, although only examples in English are given here, similar mechanisms can be implemented for any other language with the help of a Natural Language Understanding module.

A typical example of a forwarded e-mail establishing a notification configuration using this method may look like is illustrated in FIG. 2. The sender the user wishes to be notified about can be extracted from the original message 50. This may be accomplished using text filtering as e-mail typically has a standard format. For example, the system may be programmed to extract the e-mail address from the forwarded message found in the body of the e-mail, e.g. the e-mail address following the second occurrence of “From:”. Natural language configurations can be placed in the subject line 55 of the forwarded e-mail. The notification system is able to determine who the notification is to be sent to from the address line 60, e.g. the address following the first occurrence of “From:”

In applications where the user is using an e-mail reader, establishing a notification configuration using natural language can be performed by voice commands. Date and time criteria may also be added using voice commands in natural language expressions as mentioned above. Examples of such configurations are disclosed below.

In another embodiment the notification configuration may be specified using a web interface. In this embodiment the user, using a web browser, such as Explorer, Netscape, Opera, or Mozilla, goes to a specific website where the user may specify his or her notification criteria. This may be accomplished using an online form where the user fills in the information. In some embodiments, the user may use natural language expressions to enter a configuration. Other embodiments, applications, or features will be apparent to one skilled in the art given the benefit of this disclosure.

The second step of the method includes generating one or more notification criteria correlated to the notification configuration. In certain preferred embodiments this is where the notification system sets up a notification based on the information provided to the system. In the case of the forwarded e-mail example provided above, the user to whom the notification is to be sent is extracted from the forwarded e-mail and correlated to the criteria which identify the user such as his or her phone number or other communication identifier for the user's mobile communication device. The sender of the original e-mail for which notifications will be generated is extracted from the body of the forwarded e-mail and set as the trigger for notification. There may also be additional criteria such as time and date requirements for notification that may be user defined or pre-set.

In the case where natural language expressions are used to provide a configuration, the process of correlation involves using a Natural Language Understanding (NLU) module. This module is capable of processing the natural language expressions and correlating them with machine understandable criteria for notification. The NLU module may use a grammar or a stochastic approach to extract the meaning of the user's setting. Examples of suitable natural language converters and correlation techniques can be found in Boda, P.: “From stochastic speech recognition to understanding: an HMM-based approach”; ASRU'97-IEEE Workshop on Automatic Speech Recognition & Understanding, Santa Barbara, Calif., USA, 14-17 Dec. 1997; and Dobrin, C. & Boda, P.: “Resolution of date and time expressions in a WWW-based dialogue system” COST 249 (Continuous Speech recognition over the Telephone) Workshop, Porto, Portugal, February, 1998. Other implementation and applications will be apparent to one skilled in the art given the benefit of this disclosure.

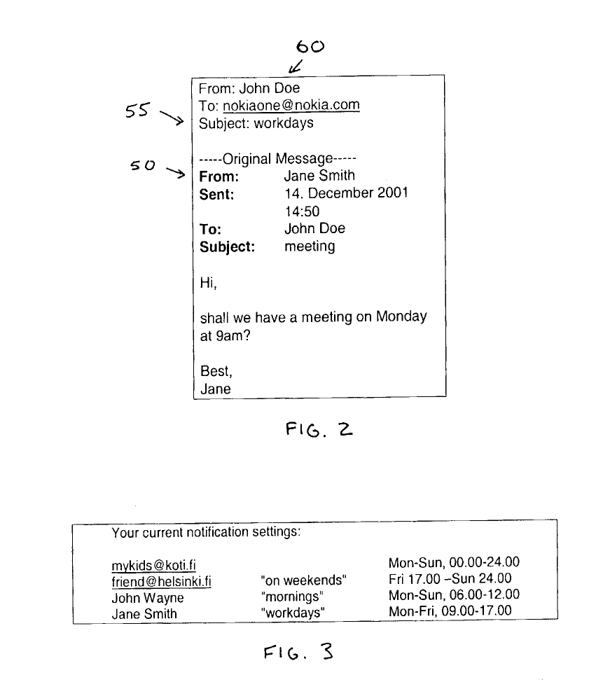

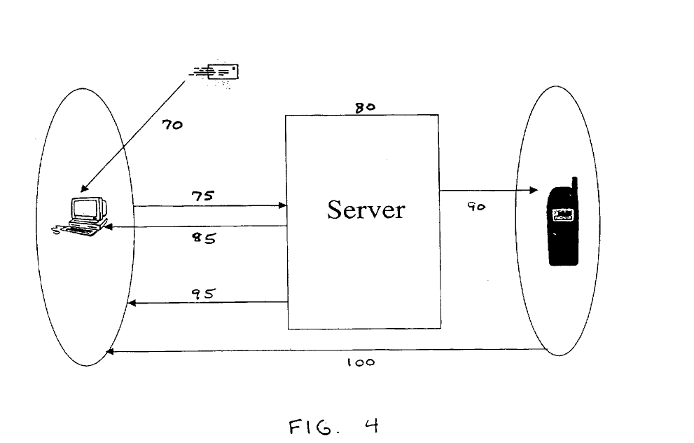

An optional third step of the method includes providing the one or more notification criteria for confirmation. The criteria are what the system has interpreted as the data to be used to set up the configuration, e.g. notification to Joe Smith for John Doe's e-mails arriving between 9:00 am to 5:00 pm. The confirmation may be provided by e-mail, web interface, or by a speech capable system. An example of how an e-mail confirmation might look in the e-mail based example is illustrated in FIG. 3.

In certain preferred embodiments, where the method further comprises the step of editing the notification criteria based on the notification criteria provided for confirmation, the criteria can be modified by replying to the notification criteria provided for confirmation. In the given e-mail example, this may involve sending back an edited notification confirmation to the system. In the speech-enabled example the notification confirmation can be edited with voice commands. The notification criteria may also be accessed any time the user wishes to edit the notification criteria. One method is by using a voice command e.g. “what are my notification settings.” The editing of the notification criteria allows the user to make sure he or she will receive the desired notification(s). The editing of the confirmation criteria also allows the user to effectively teach the system what the user means by his or her natural language expressions given in the configuration step.

An example of a speech-enabled notification set-up including providing notification configuration using natural language and receiving confirmation of the notification criteria may resemble the following:

System: “Hello John, you have 4 new mails.”“The first mail is from Jane Doe, subject . . . ”

User: “Set notification.”

System: “When do you want to be notified?”

User: “In the mornings.”

System: “Setting notification for Jane Doe's mails arriving in the mornings.”“Is that correct?”

User: “Yes, that is correct.”

In the above example a notification will be generated when the user receives an e-mail from Jane Doe in the morning. Additional criteria may also include when the user wishes to receive notification, e.g. “in the evening” or keyword appearing in the subject line of the e-mail.

The examples here show just a few of the possible implementations. Other implementations for providing notification configurations, receiving confirmation of notification criteria, and editing notification criteria will be apparent to one skilled in the art given the benefit of this disclosure.

In accordance with another embodiment, the notification system has a processor, that upon executing computer executable instructions, performs the following steps:

receiving a notification configuration from a user, con-elating the notification configuration provided by the user to at least one notification criteria, and notifying the user of communication meeting the at least one notification criteria.

In certain preferred embodiments the instructions, when executed, perform the step of providing the notification criteria to the user. In additional preferred embodiments the instructions, when executed, perform the step of receiving further configuration in response to provided notification criteria. In another embodiment the system is capable of performing the step of providing notification to the user when notification criteria are met.

As described above and shown in FIG. 1, in a typical embodiment the system, as used in a wireless network, may include a server 10 in communication with a user's personal computer 35 and a mobile communication device 15. The communication with the user's personal computer is through the Internet 30 or other suitable connection for transmitting data. The communication with the user's mobile communication device 15 may be by any suitable wireless transmission technology 20 (including CDMA, GSM, TDMA, SMS, WAP, Bluetooth, Wi-fi, and others) or media (radio, infrared, laser, and the like). The server is described in more detail below. In applications where the user's e-mail is provided by a web based service or stored on a server the notification system is in communication with the server storing the e-mail or providing the web based service.

The notification configuration received from a user by the system includes those described above in the method of setting up a notification. They include e-mail, web interfaces, and voice commands sent to the system. Other methods of receiving notification configurations will be apparent to one skilled in the art given the benefit of this disclosure.

The step of correlating the notification configuration to notification criteria is performed, as described above, by the processor. In applications using natural language expressions, a natural language converter or Natural Language Understanding (NLU) module may be part of the system. The NLU can be part of the processor or a separate module. The NLU module is capable of processing and correlating the natural language expressions with machine understandable criteria for notification. The NLU module may use a grammar or stochastic approach to correlation. Examples of suitable natural language converters and correlation techniques can be found as indicated above. Other implementations and applications will be apparent to one skilled in the art given the benefit of this disclosure.

The complexity of implementing such correlation is reduced by using an e-mail protocol as in the examples given above. Using the e-mail format allows for text filtering because e-mails, and more specifically forwarded e-mails, tend to have a specific syntax. Therefore, the server only has to focus on specific areas, e.g. the subject line when correlating natural language expressions to notification criteria. In examples where voice commands are used to set up a notification, the system may involve more complexity. For example, the system may be capable of recognizing and correlating natural language voice commands or the system may convert the voice commands to text and then correlate the natural language expressions to notification criteria. It should be understood that by no means are these the only possible implementations. Other implementations and applications will be apparent to one skilled in the art given the benefit of this disclosure.

The optional step of providing the notification criteria to the user allows the user to confirm or edit the notification criteria he or she has set up. The system has received the notification configuration. The system has correlated the notification configuration provided by the user to the notification criteria. The system now provides the criteria it has con-elated to the configuration to the user for confirmation. In cases where natural language expressions are used, this also indicates to the user if the NLU module has properly correlated the user's natural language configuration to the correct notification criteria. The notification criteria can be provided by e-mail, over a web interface, or if the notification system is speech capable, audibly. The notification criteria may also be accessed any time the user wishes to edit the notification criteria. One method is by using a voice command e.g. “what are my notification settings.” Other implementations and configurations will be apparent to one skilled in the art given the benefit of this disclosure.

In certain additional preferred embodiments the notification system is capable of receiving further configuration in response to the provided notification criteria. This allows the user to modify the notification criteria if the provided notification criteria are not correct or if the user wants to update them. This also provides a means for the NLU module to learn what criteria it should correlate to specific natural language expressions. The further configuration may also be received by e-mail, web interface, or voice commands in a manner similar to those disclosed above. Other implementations and applications will be apparent to one skilled in the art given the benefit of this disclosure.

In another embodiment the system is may notify the user when the notification criteria are met. This is the actual notification that the user has set up. When the notification criteria that the user has set up are met the system generates or causes to be generated a notification to the user. Typically the notification is sent to the user's mobile communication device, such as a mobile phone handset. In a preferred embodiment the notification is sent as an SMS or MMS message. The message may also contain an indication of how to access the e-mail or other basis for the notification using the mobile communication device. In other embodiments the notification may be a call to the user on the user's mobile communication device wherein the e-mail or other basis for the notification is read by a speech enabled notification system. The notification system is capable of directing the user to the e-mail, or basis for notification, because the system set a focus on the basis for notification, e.g. the e-mail. The focus acts as a pointer or indicator for the e-mail that caused the notification. In embodiments where an e-mail reader is employed the focus also indicates what e-mail is to be read.

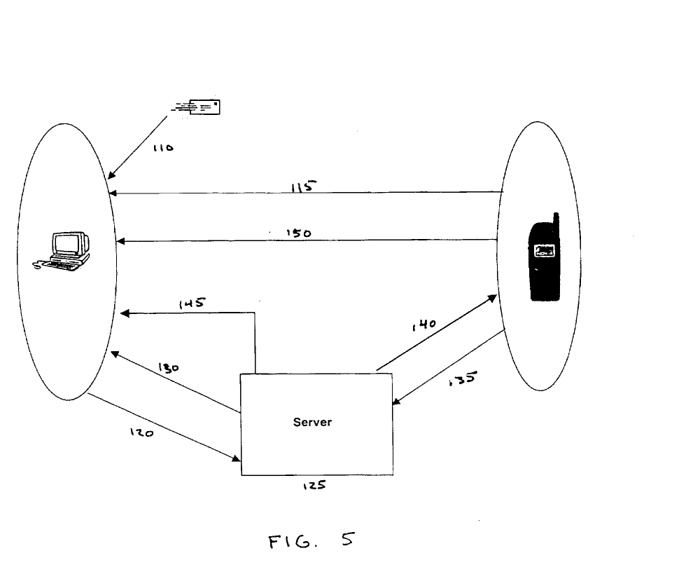

An example of how the notification system can be set up using a personal computer using traditional e-mail protocol can be seen in FIG. 4. Initially an e-mail arrives 70 in the user's inbox. The e-mail is then forwarded 75 to the server 80 of the notification system with natural language time and date configurations. The sender's address is extracted from the forwarded e-mail using text filtering, date and time configurations are extracted from the subject line and correlated to notification criteria, and a notification is set up at the server 80. The correlated notification criteria are sent back for confirmation or further configuration 85. If an e-mail arrives which meets the notification criteria, a notification is sent 90. After the notification is sent a focus is set on the notified e-mail 95. The user can then check the notified e-mail 100 because the e-mail is already “queued up” by the focus. When using an e-mail reader, the notified e-mail is read out to the user.

Another example of how the notification system is configured by voice commands using a mobile communication device can be seen in FIG. 5. E-mail arrives 110 in the user's inbox. The user browses e-mail using voice commands and selects an e-mail for notification providing date and time configuration using natural language expressions 115. An e-mail is forwarded 120 to the server 125 of the notification system. The subject line contains the date and time configurations optionally in natural language. The sender's address is extracted from the forwarded e-mail using text filtering, date and time configurations are extracted from the subject line and correlated to notification criteria, and a notification is set up at the server 125. Confirmation of the notification criteria is provided 130. The user may also browse, select and modify notification criteria using voice commands 135. Notification is sent 140 when an e-mail arrives meeting the notification criteria. After notification is sent a focus is set 145 on the notified e-mail. The user may then access the notified e-mail 150 because the e-mail is already “queued up” by the focus. If an e-mail reader is used the e-mail can be read out to the user.

It should be noted that these examples are just some of the possible implementations.

Setting up notification and accessing the notification criteria using a mobile communication device does not require using voice commands. The user may use e-mail or web capabilities of the device or may use a touch-tone interface commonly used in conjunction with telephone-based services. The user may also use a traditional telephone system to set up and use the notification system. In other embodiments the server may provide the speech capability of an e-mail reader, reducing the complexity and cost of implementation for the user. Other embodiments and implementations will be apparent to one skilled in the art given the benefit of this disclosure.

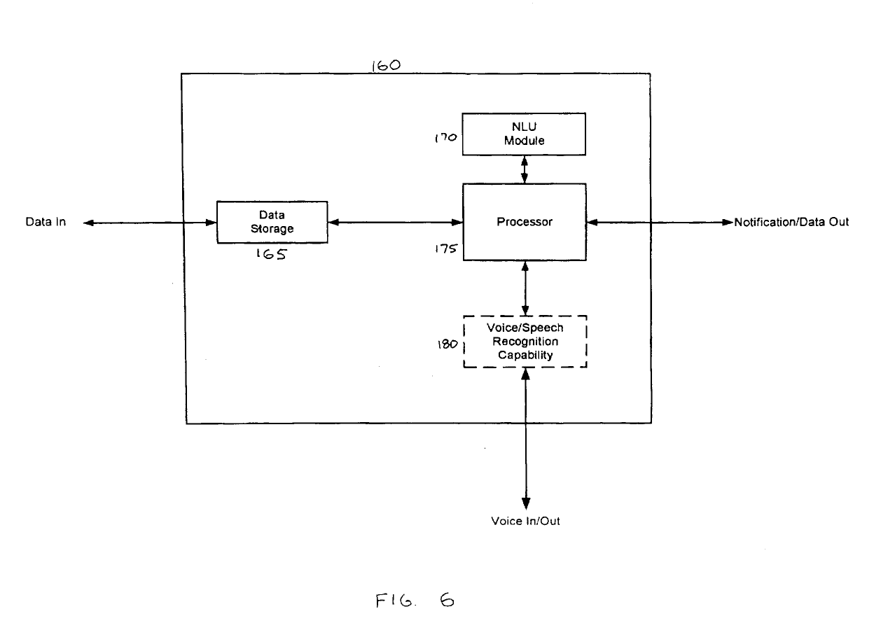

As shown in FIG. 6, in accordance with an illustrative aspect of the invention, a server 160 suitable for providing notification to a user of a mobile communication device includes a storage device 165 for storing at least one notification configuration received from a user and the corresponding notification criteria, and a processor 175 in communication with the storage device that correlates the notification configuration to the notification criteria and provides notification to the user when a received communication meets the notification criteria. In this embodiment a separate NLU module 170 is used to correlate natural language expressions to notification criteria. In other embodiments the NLU may be incorporated into the processor 175. In certain preferred embodiments the server also includes speech recognition and capability 180. In some embodiments the speech recognition and capability 180 may also be incorporated into the processor 175.

The storage device 165 holds the notification configuration provided by the user as well as the notification criteria that has been correlated to the notification configuration. Suitable storage devices include any device for storing data including but not limited to RAM, SDRAM, Programmable memory, hard drives, optical storage media, removable storage media, or the like. In certain embodiments the storage device may store the focus on the basis for the notification, such as an e-mail. The focus acts like a pointer providing a path to the e-mail, or other basis for notification, so that the user may easily access the basis for notification.

The processor 175 controls the system, allowing the server to receive notification configurations from a user, convert them to notification criteria, provide the corresponding criteria to the user, set up the notification, and provide notification when the criteria are met. Examples of suitable processors include, but are not limited to those produced by Intel, Motorola, SUN, Advanced Micro Devices, and the like.

The natural language converter 170, also referred to as an NLU module, receives notification configurations from the storage device, correlates the natural language configuration to notification criteria, and outputs the notification criteria. The natural language converter may use a grammar or a stochastic-based approach to correlation. In some embodiments, the natural language converter is part of the processor 175.

In embodiments where there is an e-mail reader and voice commands are used, the server may include speech recognition and speech generation capability 180 for generating the audible e-mail and receiving voice commands. This may be a separate module or it may be incorporated into the processor 175.

In another embodiment the user may use natural language expressions, other than date and time, to set up notifications for information or data other than e-mails from specific senders. The user may set up notifications for cultural events in a specified city/region/country, weather reports, traffic updates, stock prices, travel information, advertisements and other items of interest to the user. For example, the user may be traveling abroad and want information about certain countries, sights, things to do, etc. The user may want this information before the trip, or even during it. The user can then send the following request to the system: “tourist trip, Italy, Ischia, between July 1^{st} and July 15^{th}, rock concerts, museums, sights to see, report once a day.”When this message is received, the system interprets the request and once a day prepares e-mail(s) about Ischia including tourist information, rock concerts, and museums during the given period.

Though the embodiments described here are directed to e-mail protocols, the methods and systems disclosed are equally applicable to other modes or methods of personal communication, including but not limited to personal messaging, voice-mail, and other possible future forms of personal communication. It should be understood that the examples and embodiments disclosed here are but a few of the possible implementations, configurations, and embodiments. Other implementations, configurations, substitutions, modifications, alterations and embodiments will be apparent to one skilled in the art given the benefit of this disclosure. It will also be recognized by those skilled in the art that the steps described here can be performed in any order so as to provide notification to the user.

What is claimed is:

1. A method of setting up a notification for a user of a mobile communication device, the method comprising:
receiving a notification configuration from a user; and
generating one or more notification criteria correlated to the notification configuration;
whereby the user is notified of communication meeting the notification criteria.

2. The method of claim 1, wherein said receiving a notification configuration from a user comprises receiving an e-mail having the notification configuration.

3. The method of claim 2, wherein said generating one or more notification criteria from a user comprises extracting an e-mail address of the user from the e-mail and correlating the e-mail address to notification criteria.

4. The method of claim 2, wherein said receiving a notification configuration from a user comprises receiving a forwarded e-mail having the notification configuration.

5. The method of claim 4, wherein said generating one or more notification criteria comprises extracting an e-mail address of a sender of an original e-mail from the forwarded e-mail as criteria for notification.

6. The method of claim 1, wherein said receiving a notification configuration from a user comprises receiving the notification configuration using a web-interface.

7. The method of claim 1, wherein said receiving a notification configuration from a user comprises receiving the notification configuration from the mobile communication device.

8. The method of claim 1, wherein said receiving a notification configuration from a user comprises receiving the notification configuration, at least partially, by natural language.

9. The method of claim 8, wherein said receiving a notification configuration from a user comprises receiving a notification configuration using a speech-enabled interface.

10. The method of claim 8, wherein said generating one or more notification criteria correlated to the notification configuration comprises converting natural language into machine-understandable criteria.

11. The method of claim 1, further comprising providing the one or more notification criteria for confirmation.

12. The method of claim 11, wherein said providing the one or more notification criteria for confirmation comprises using e-mail to provide the one or more notification criteria.

13. The method of claim 11, wherein said providing the one or more notification criteria for confirmation comprises using a web interface to provide the one or more notification criteria.

14. The method of claim 11, wherein said providing the one or more notification criteria for confirmation comprises using a speech-enabled interface to provide the notification criteria.

15. The method of claim 11, further comprising receiving editing of the one or more notification criteria provided for confirmation.

16. The method of claim 15, wherein said receiving editing of the one or more notification criteria provided for confirmation comprises receiving an e-mail having the editing.

17. The method of claim 15, wherein said receiving editing of one or more notification criteria provided for confirmation comprises using a web interface to receive the editing.

18. The method of claim 15, wherein said receiving editing of the one or more notification criteria provided for confirmation comprises receiving the editing from the mobile communication device.

19. The method of claim 15, wherein said receiving editing of the one or more notification criteria provided for confirmation comprises receiving the editing, at least partially, by natural language.

20. The method of claim 19, wherein said receiving editing of the one or more notification criteria provided for confirmation comprises using a speech-enabled interface to receive the editing.

21. A notification system comprising a processor, that upon executing computer executable instructions, performs the steps comprising:
receiving a notification configuration from a user;
correlating the notification configuration provided by the user to at least one notification criteria; and
notifying the user of communication meeting the at least one notification criteria.

22. The system of claim 21, wherein said receiving a notification configuration from a user comprises receiving an e-mail having the notification configuration.

23. The system of claim 21, wherein said receiving a notification configuration from a user comprises receiving the notification configuration using a web interface.

24. The system of claim 21, wherein said receiving a notification configuration from a user comprises receiving the notification configuration from a mobile communication device.

25. The system of claim 24, wherein said receiving a notification configuration from a user comprises receiving the notification configuration, at least partially, by natural language.

26. The system of claim 25, wherein said receiving a notification configuration from a user comprises receiving the notification configuration using a speech-enabled interface.

27. The system of claim 25, wherein said correlating the notification configuration to notification criteria comprises converting natural language into machine-understandable criteria.

28. The system of claim 21, wherein said processor further performs the step comprising providing the notification criteria for confirmation.

29. The system of claim 28, wherein said providing the notification criteria for confirmation comprises using e-mail to provide the notification criteria.

30. The system of claim 28, wherein said providing the notification criteria for confirmation comprises using a web interface to provide the notification criteria.

31. The system of claim 28, wherein said providing the notification criteria for confirmation comprises using a speech-enabled interface to provide the notification configuration.

32. The system of claim 28, wherein said processor further performs the step comprising receiving further notification configuration in response to provided notification criteria.

33. The system of claim 32, wherein said receiving further notification configuration in response to provided notification criteria comprises receiving e-mail having the further notification configuration.

34. The system of claim 32, wherein said receiving further notification configuration in response to provided notification criteria comprises receiving further notification configuration using a web interface.

35. The system of claim 32, wherein said receiving further notification configuration in response to provided notification criteria comprises receiving further notification configuration from a mobile communication device.

36. The system of claim 32, wherein said receiving further notification configuration in response to provided notification criteria comprises receiving further notification configuration, at least partially, by natural language.

37. The system of claim 36, wherein said receiving further notification configuration in response to provided notification criteria comprises receiving further notification configuration using a speech-enabled interface.

38. The system of claim 21, wherein said processor further performs the step comprising providing notification to a mobile communication device when the at least one notification criteria is met.

39. A server for providing notification to a user of a mobile communication device, the server comprising:
a storage device for storing at least one notification configuration received from a user and notification criteria; and
a processor in communication with the storage device that correlates the notification configuration to the notification criteria and provides notification to the user when received communication meets the notification criteria.

40. The server of claim 39, wherein said notification configuration received from a user comprises a notification configuration received by e-mail.

41. The server of claim 39, wherein said notification configuration received from a user comprises a notification configuration received from a web interface.

42. The server of claim 39, wherein said notification configuration received from a user comprises a notification configuration received from a mobile communication device.

43. The server of claim 39, further comprising a natural language conversion module for converting natural language expressions to notification criteria.

44. The server of claim 43, further comprising a speech-enabled interface for converting voice commands into text which is then converted by the natural language conversion module to notification criteria.

45. A mobile communication device comprising a processor, that upon executing computer executable instructions, performs the steps comprising:
providing a notification configuration from a user to a notification service using natural language; and
notifying the user when notification is received from the notification service.

46. A method of setting up a notification using a mobile communication device, the method comprising:
viewing a message on the mobile communication device;
forwarding the message to a notification service and using natural language to specify criteria for notification of future messages;
receiving the forwarded message at the notification service;
extracting a sender of the original message from the forwarded message and associating the extracted sender with the criteria for notification of future messages from the sender;
sending a confirmation of the criteria to the mobile communication device; and
upon receipt of a message from the sender that meets the criteria for notification, sending a notification to the mobile communication device.
